(19) United States
(12) Patent Application Publication
(10) Pub. No.: US 2017/0355410 A1
(43) Pub. Date: Dec. 14, 2017

(54) AIR CUSHION SADDLE

(71) Applicant: Yongpil YIM, Incheon (KR)

(72) Inventor: Yongpil YIM, Incheon (KR)

(21) Appl. No.: 15/540,563

(22) PCT Filed: Dec. 28, 2015
(86) PCT No.: PCT/KR2015/014351

§ 371 Date: Jun. 28, 2017

(30) Foreign Application Priority Data
Dec. 29, 2014 (KR) 10-2014-0192243
Dec. 28, 2015 (KR) 10-2015-0187120

(51) Int. Cl. B62J 1/26; B62J 1/28; B62J 1/08; B32B 5/18

(52) U.S. Cl. CPC B62J 1/26; B62J 1/08; B62J 1/28; B32B 5/18

(57) ABSTRACT

The objective of the present invention is to provide an air cushion saddle which includes a cushion member formed of a rubber material with high elasticity and tension, with a closed space where air is injected being formed within the cushion member, thereby relieving saddle pain caused by frequent road friction and impact and allowing comfortable riding when a user rides a bicycle.

### TECHNICAL FIELD

The present invention relates to an air cushion saddle, and more particularly, to an air cushion saddle for relieving a musculoskeletal system or dermalgia caused around the pelvis and allowing the circulation of the blood circulation to be smoothly perform when a user rides a bicycle for a long time.

### BACKGROUND ART

When a user rides a bicycle for a long time, the biggest pain is a saddle pain.

A user feels a saddle pain when he or she uses a wide chair at normal times and changes to a narrow saddle. He or she has to go through some period of adjustment to some extent and experiences trial and error several times.

Each user has a different pelvic width and the area that touches the saddle is also different. Each user is different depending on the shape of the pelvis or the shape of pelvic muscles. Accordingly, the saddle may be or may not be fit into a user just as it is perfect with a user.

In addition, a shooting symptom may be generated if the blood is not circulated for a long time because a pressure point is located close to the saddle.

In general, there are basically two types of saddle pains that occur when a user rides a bicycle. First, there is a pain generated because vibration from a road surface is transferred to the saddle, resulting in a shock on the hip. Second, there is a pain generated because the skin continues to be stimulated due to the friction between the saddle and the hip.

In particular, in order to solve the saddle pain caused by the impact, in a conventional, a shock absorber was installed between the saddle and a bicycle frame. However, in this case, middle and higher class riders tend to be reluctant to use the shock absorber because the weight of the bicycle itself increases.

In addition, each user has a different hipbone shape and a different sciatic size in the hip, whereas the shape of the saddle is fixed. Accordingly, it is costly to adjust the saddle to fit each rider one by one.

In addition, although the size is correct, a conventional saddle cannot solve the problem of a pain upon riding for a long time because the saddle is made of a hard material and thus hinders a blood flow of the prostate gland or the lower part of the body.

### SUMMARY OF THE INVENTION

### Technical Problem

Various aspects of the present invention are directed to providing an air cushion saddle, which includes a cushion member formed of a rubber material with high elasticity and tension, with a closed space where air is injected being formed within the cushion member, thereby relieving saddle pain caused by frequent road friction and impact and allowing comfortable riding when a user rides a bicycle.

### Technical Solution

An air cushion saddle according to a first exemplary embodiment of the present disclosure may include: a base plate 100 mounted on a bicycle frame 10; a cushion member 200 mounted on the top of the base plate 100, formed of a rubber material, and having a closed space 200a in which air is injected being formed therein; and a valve member 300 disposed in the cushion member 200 to open and close the closed space 200a.

A first venthole 110 vertically penetrated is formed in the base plate 100. A Second venthole 230 for distributing pressure and circulating air upon coming into contact with a body are vertically penetrated and formed in the cushion member 200 in such a way as to communicate with the first venthole 110.

The cushion member 200 may include a front portion 210 which is disposed between the thighs of a rider and a rear portion 220 which has a wider width than the front portion and in which the hips of the rider are disposed. The second venthole 230 include a front venthole 231 formed in an oval long in the length direction of the cushion member 200 and disposed at the center of the front portion 210; and two rear venthole 232 formed in a circular shape and spaced apart from each other on the left and right sides of the rear portion 220.

Stiffening portion 240 formed of a synthetic resin material having a higher tensile force than the material of the cushion member 200 are formed on the front and rear surfaces of the cushion member 200.

Sliding portion 250 having a plurality of concave-convex parts are formed on both sides of the cushion member 200 in order to reduce friction with insides of thigh of a rider. Non-slipping portion 260 made of an adhesive material are formed on the top of the cushion member 200 in order to prevent slip through contact with the hip portion of the rider.

An air cushion saddle according to a second exemplary embodiment of the present disclosure may include: a base plate 1100 mounted on a bicycle frame and having a first venthole 1110 vertically penetrated formed therein; a cushion member 1200 mounted on the top of the base plate 1100, formed of a rubber material, having a closed space 1221 in which air is received formed therein, and having second venthole 1230 for distributing pressure and circulating air upon coming into contact with a body vertically penetrated and formed therein in such a way as to communicate with the first venthole 1110; and a valve member 1300 disposed in the cushion member 1200 to open and close the closed space 1221. The cushion member 1200 may include: a lower plate 1210 mounted on the base plate 1100; and an upper cover 1220 mounted on the lower plate 1210 and having a closed space 1221 formed therein, the closed space having a bottom open and the inside upward concaved and being sealed by the lower plate 1210.

The air cushion saddle may further include: an anchor member 1400 for closely fixing the cushion member 1200 to the base plate 1100. The anchor member 1400 may include a body portion 1410 inserted into the first venthole 1110 and the second venthole 1230 therethrough;

a support portion 1420 extended from one end of the body portion 1410 and closely attached to any one surface of the base plate 1100 and the cushion member 1200; and a hook portion 1430 formed at the other end of the body portion 1410 and hooked to the other surface of the base plate 1100 and the cushion member 1200.

The support portion 1420 is closely fixed to the cushion member 1200. A contact portion 1221 coming into contact with the support portion 1420 is extended and formed along an inner circumferential surface at the bottom of the second venthole 1230 of the cushion member 1200. Fixing protrusion 1421 fixed to be embedded in the contact portion 1221 when the fixing protrusion 1421 are closely attached to the contact portion 1221 are formed in the support portion 1420.

The air cushion saddle may further include: a bolt member 1500 coupling the base plate 1100 and the cushion member 1200. A first bolt hole 1120 protruded in the direction of the cushion member 1200 and having the bolt member 1500 fastened therein is formed in the base plate 1100. A second bolt hole 1222 connected to the first bolt hole and having the bolt member 1500 fastened therein is formed in the cushion member 1200.

The cushion member 1200 includes a front portion 1220a which is disposed between the thighs of a rider and a rear portion 1220b which has a wider width than the front portion 1220a and in which the hips of the rider are disposed. The second venthole 1230 include a front venthole 1230a formed in an oval long in the length direction of the cushion member 1200 and disposed at the center of the front portion 1220a; and two rear venthole 1230b each having a circular shape and spaced apart from each other on the left and right sides of the rear portion 1220b. A ventilation 1223 open between the rear venthole 1230b from the front venthole 1230a is formed in the cushion member 1200.

The aforementioned air cushion saddle of the present invention has the following effects.

In the case of the first exemplary embodiment, there are effects in that the occurrence of a saddle pain may be reduced and ride comfort may be improved, thereby relieving a shock applied to the body of a rider because the cushion member 200 is formed of a rubber material and the closed space 200a where air is injected being formed within the cushion member 200.

There is an effect of minimizing the occurrence of a pain upon riding for a long time by stopping excessive pressure and pressing and circulating air when the saddle comes into contact with the body of a rider because the second venthole 230 are formed in the cushion member 200 as described above.

There is an effect of preventing the cushion member 200 from being damaged although weight excessively shifts or an external shock is applied to the cushion member 200 because the stiffening portions 240 are formed in the cushion member 200.

There is an effect of preventing damage to the skin by preventing the inside of the thighs from being chafed because the sliding portion 250 are formed in the cushion member 200.

There is an effect of improving a feeling of stability by preventing the hip portion of a rider from slipping while driving because the non-slip portion 260 are formed in the cushion member 200.

In addition, in the case of the second exemplary embodiment, there are effects in that a saddle pain attributable to frequent friction and impacts of a road surface can be solved and ride comfort is provided upon riding a bicycle because the closed space 1221 in which the air is injected being formed within the cushion member 1200 made of a rubber material having high elasticity and tensile force.

In particular, there are effects in that fabrication is convenient due to a simplified configuration and the upper cover 1220 can be easily replaced and repaired when it is damaged because the cushion member 1200 is separated into the lower plate 1210 and the upper cover 1220.

There are effects in that sweating between the thighs can be minimized upon riding a bicycle for a long time because the ventilation 1223 is formed in the upper cover 1220 from the front venthole 1230a to the rear side and thus the occurrence of a pain is reduced by reducing friction with the upper cover 1220.

There is an effect of improving the airtightness of the closed space 1221 formed between the lower plate 1210 and the upper cover 1220 by increasing the contact area of the lower plate 1210 and the upper cover 1220 when the cushion member 1200 is mounted on the base plate 1100 because the first wing part 1211 and the second wing part 1224 are formed in the cushion member 1200 so that is increased to improve.

There are effects in that the occurrence of a pain can be further reduced and air can be circulated upon riding by distributing pressure and circulating external air into each venthole through the effects of air pressure within the closed inside upon coming into contact with the body and the cushion member made of rubber having high elasticity and tensile force because the closed space 1221 in which air is received is formed and the second venthole 1230 communicating with the first venthole 1110 is formed within the cushion member 1200.

### BRIEF DESCRIPTION OF THE DRAWINGS

FIG. 1 is a perspective view of an air cushion saddle in one direction according to the first exemplary embodiment of the present invention,

FIG. 2 is a perspective view of an air cushion saddle according to the first exemplary embodiment of the present invention in another direction,

FIG. 3 is an exploded perspective view of an air cushion saddle according to the first exemplary embodiment of the present invention,

FIG. 4 is a cross-sectional view taken along line A-A of FIG. 1,

FIG. 5 is a cross-sectional view taken along line B-B of FIG. 1,

FIG. 6 is a perspective view of an air cushion saddle according to the second exemplary embodiment of the present invention,

FIG. 7 is an exploded perspective view of an air cushion saddle in one direction according to the second exemplary embodiment of the present invention,

FIG. 8 is an exploded perspective view of an air cushion saddle in another direction according to the second exemplary embodiment of the present invention,

FIG. 9 is an enlarged perspective view of an anchor member according to the second exemplary embodiment of the present invention,

FIG. 10 is a cross-sectional view of an air cushion saddle according to the second exemplary embodiment of the present invention.

### BEST MODE FOR INVENTION

The present invention provides an air cushion saddle, may include a base plate 100 mounted on a bicycle frame 10;

a cushion member 200 mounted on the top of the base plate 100, formed of a rubber material, and with a closed space 200a in which air is received being formed within the cushion member; and a valve member 300 disposed in the cushion member 200 to open and close the closed space 200a.

### DETAILED DESCRIPTION OF THE EMBODIMENTS

Hereinafter, the present invention is described in detail with reference to the accompanying drawings and proposed embodiments.

### First Exemplary Embodiment

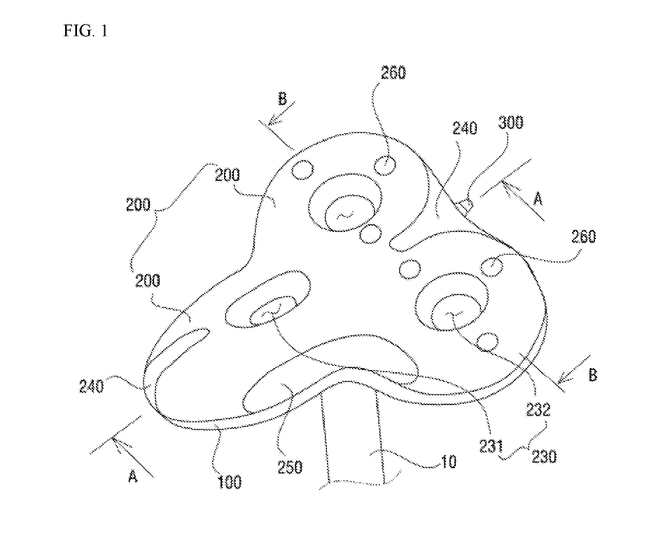

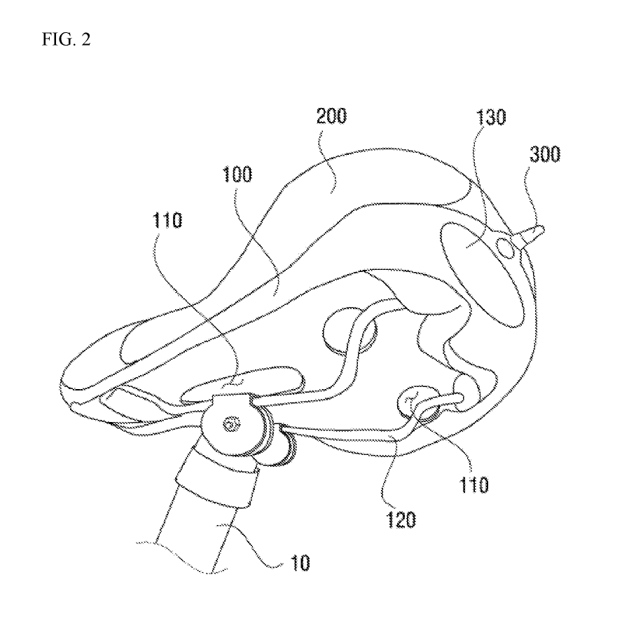

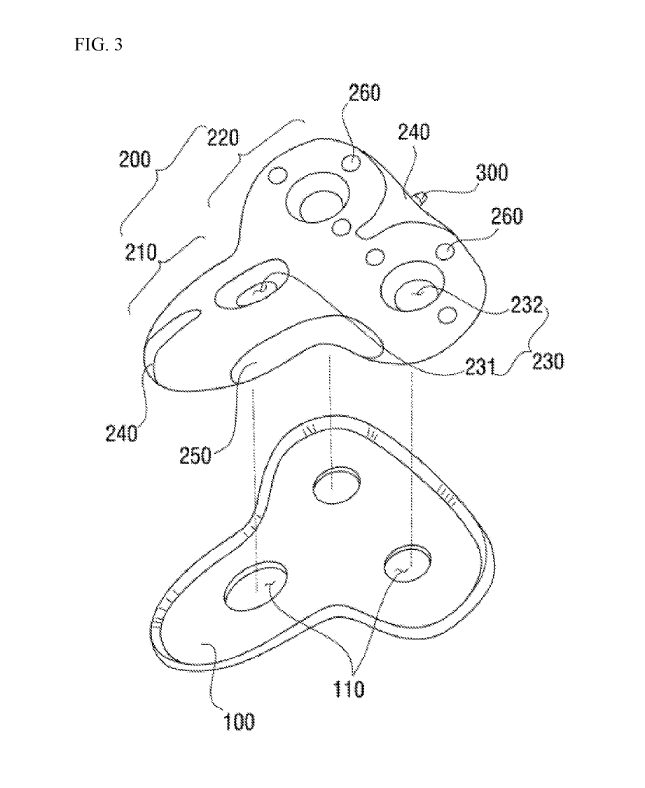

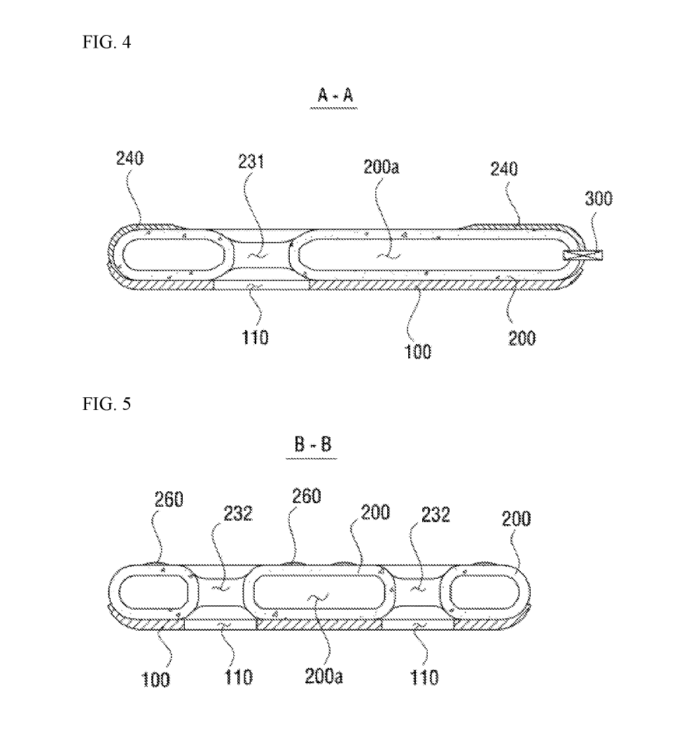

FIG. 1 is a perspective view of an air cushion saddle in one direction according to the first exemplary embodiment of the present invention, FIG. 2 is a perspective view of an air cushion saddle in another direction according to the first exemplary embodiment of the present invention , FIG. 3 is an exploded perspective view of an air cushion saddle according to the first exemplary embodiment of the present invention, FIG. 4 is a cross-sectional view taken along line A-A of FIG. 1, and FIG. 5 is a cross-sectional view taken along line B-B of FIG. 1.

As shown in FIGS. 1 to 5, an air cushion saddle according to the first exemplary embodiment of the present invention includes a base plate 100, a cushion member 200 and a valve member 300.

The base plate 100 is for supporting the cushion member 200 to be described later. The base plate 100 is made of a hard and light synthetic resin material so as not to be easily damaged by a shock. As in the saddle of a common bicycle, the base plate has a narrow front and wide back shape and is formed flat.

In addition, the edge portion of the upper surface of the base plate 100 is slightly protruded upward to surround the lower portion of the cushion member 200 to be described later.

In addition, the first venthole 110 penetrating the upper and lower portions formed of the base plate 100.

The first venthole 110 communicate with the second venthole 230 of the cushion member 200 to be described later. The total of three ventholes, one at the center of the front and each one on both sides of the back, are provided.

In this case, the first venthole 110 disposed on the front side has an oval long shape the front and the rear direction, and the remaining two first venthole 110 have a circular shape.

Rail 120 are provided under the base plate 100 so as to be fixed to a common bicycle frame 10, and a display unit 130 capable of displaying a product logo is provided in the rear lower portion of the base plate 100.

Meanwhile, the cushion member 200 is made of a rubber material used for a vehicle tire, and a closed space 200a in which air is received being formed within the cushion member 200.

That is, the cushion member 200 has a structure which inflates when air is injected into the cushion member 200 like a common tube and maintains its shape.

The cushion member 200 is formed in a common saddle shape having a narrow front side and wide rear side like the base plate 100.

There are effects in that the occurrence of a saddle pain is reduced and ride comfort is improved by relieving a shock applied to the body of a rider because air is injected into the cushion member 200 as described above.

In addition, although a hole is generated in the cushion member 200, the cushion member can be conveniently repaired by temporarily attaching substitute rubber to the hole as in a bicycle tube and can be.

More specifically, the cushion member 200 may include a front portion 210 and a rear portion 220.

The front portion 210 is a portion disposed between the thighs of a rider and is formed to have a narrower width than the rear portion 220. The rear portion 220 is a portion extended from the front portion 210 to the back and has a wider than the front portion 210. The hip portion of a rider is disposed on the upper portion.

The second venthole 230 communicating with the first venthole 110 are formed in the cushion member 200.

Three second venthole 230 are formed like the first venthole 110.

Specifically, the second venthole 230 may include a front venthole 231 disposed at the center of the front portion 210 and rear venthole 232 disposed in the rear portion 220 and spaced apart left and right.

The front venthole 231 has an oval long shape the front and the rear direction and has the perineal region of a rider disposed therein, thereby distributing pressure applied to the perineal region and allowing air to circulate.

The rear venthole 232 are formed in a circular and have the hipbone of a rider disposed thereon to prevent the excessive pressing of the hipbone and to circulate air.

There is an effect of minimizing the occurrence of a pain upon riding for a long time by stopping excessive pressure and pressing and circulating air when the saddle comes into contact with the body of a rider because the second venthole 230 are formed in the cushion member 200 as described above.

Meanwhile, stiffening portion 240 are formed at the front and rear portions of the cushion member 200.

The stiffening portion 240 is made of a synthetic resin material having a higher tensile force than the material of the cushion member 200. The stiffening portion 240 are attached to the cushion member 200 in an insert manner during the injection molding of the cushion member 200.

The stiffening portion 240 include a first stiffening portion 240 formed in a long strip form along the upper, front and lower surfaces of the front portion of the cushion member 200 and a second stiffening portion 240 formed in an approximately triangular shape along the upper, back and lower surfaces of the rear portion of the cushion member 200.

There is an effect of preventing the cushion member 200 from being damaged although weight excessively shifts or an external shock is applied to the cushion member 200 because the stiffening portion 240 are formed in the cushion member 200 as described above.

Furthermore, sliding portion 250 are formed in the cushion member 200 in order to reduce friction with the inside of the thigh of a rider.

The sliding portion 250 is a portion having a soft surface and including a plurality of concave-convex parts made of a material not generating friction. The sliding portion 250 are formed along both sides between the front portion 210 and the rear portion 220.

The sliding portion 250 allow the inner parts of the thighs of a rider to smoothly slide in contact with the inner parts when the rider steps on the pedals.

Of course, the sliding portion 250 may be formed by attaching a film made of a fiber or vinyl material having low friction.

There is an effect of preventing damage to the skin by preventing the inside of the thighs from being chafed because the sliding portions 250 are formed in the cushion member 200 as described above.

Meanwhile, a non-slip portion 260 is formed in the upper of the cushion member 200 in order to prevent slip in contact with the hip part of a rider.

The non-slip portion 260 is provided on upper of the rear portion 220 and is made of a material having an adhesive property, such as silicon.

In addition, the non-slip portion 260 is formed in a circular form, and a plurality of the non-slip portions 260 is spaced apart from each other along the outer periphery of the second venthole 230.

There is an effect of improving a feeling of stability by preventing the hip portion of a rider from slipping while driving because the non-slip portion 260 are formed in the cushion member 200.

Meanwhile, the cushion member 200 according to the first exemplary embodiment of the present invention is fixed to the base plate 100 by an adhesive agent, but a Velcro member may be provided between the cushion member 200 and the base plate 100 so that the cushion member 200 can be attached to or detached from the base plate 100 according to circumstances.

That is, the male and female of the Velcro may be mounted on the top of the base plate 100 and bottom of the cushion member 200. Upon riding a bicycle, the cushion member 200 may be attached to the base plate 100 and may be then detached and used as a sitting mat, etc.

Meanwhile, the valve member 300 is formed of a Dunlop style valve that is the same as the tube of a bicycle wheel. A pump for charging a bicycle tube may be connected to the valve member 300 so that air is injected into the closed space 200a of the cushion member 200. When a nut at the end of the valve member 300 is released, the air within the cushion member 200 can be discharged to the outside by a pressure difference.

There is an effect of further improving ride comfort by controlling the amount of air injected into the cushion member 200 depending on the weight or body type of a rider because the valve member 300 is provided in the cushion member 200 as described above.

### Second Exemplary Embodiment

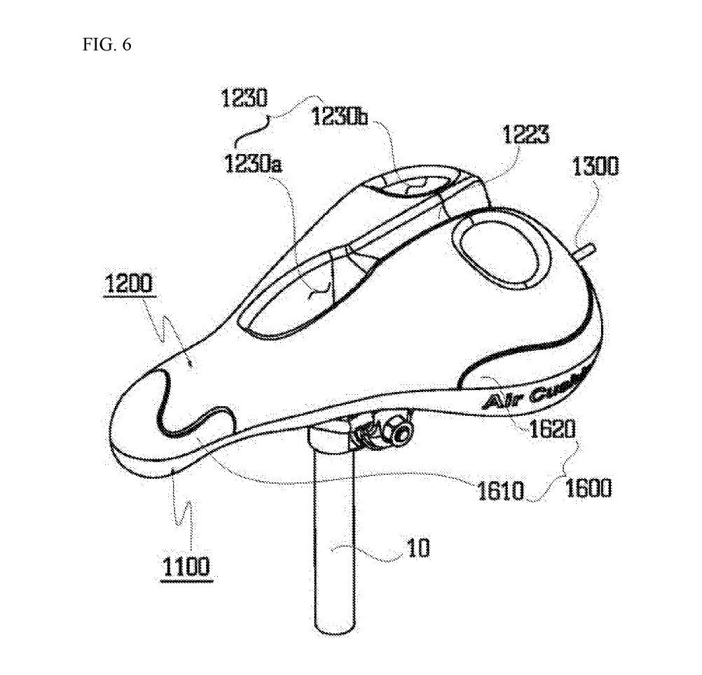

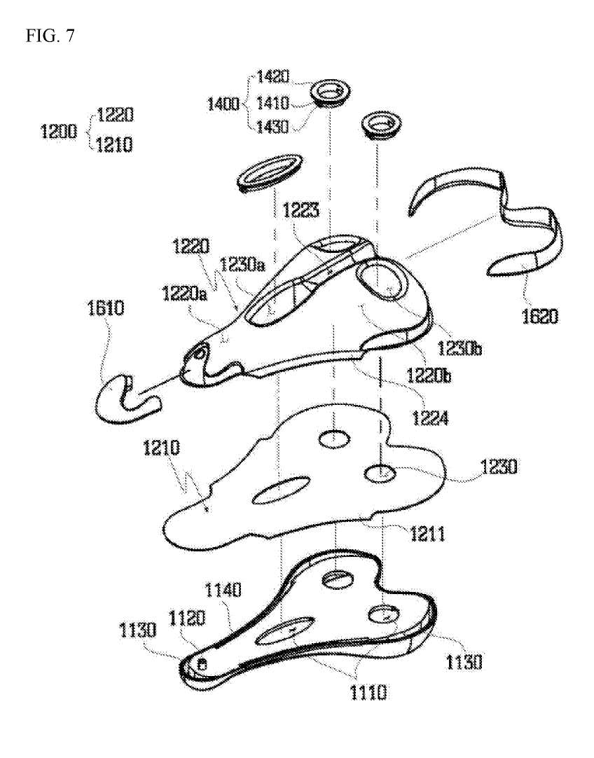

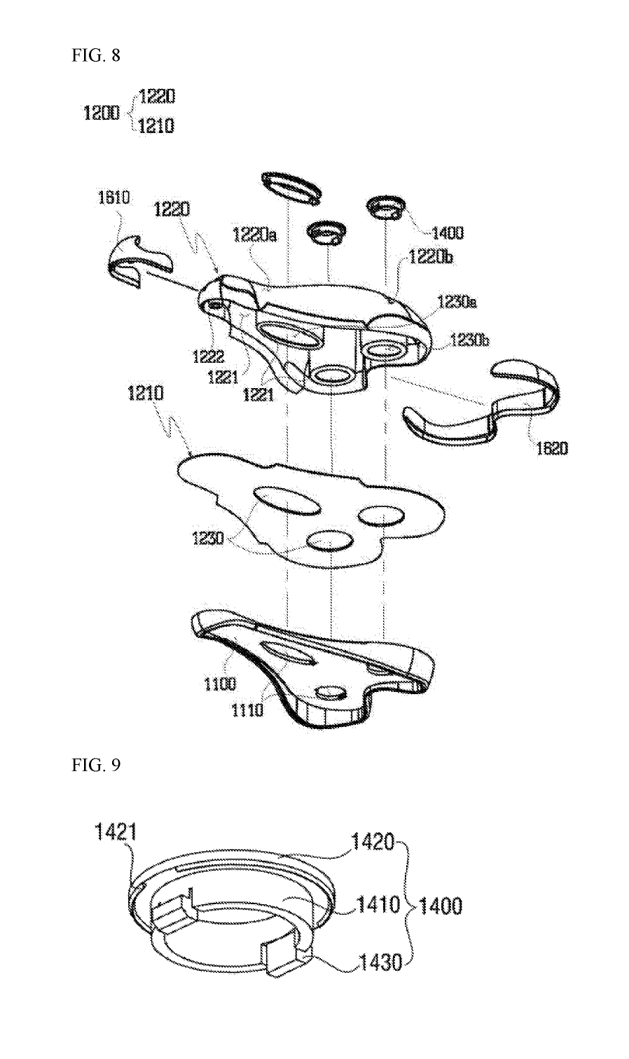

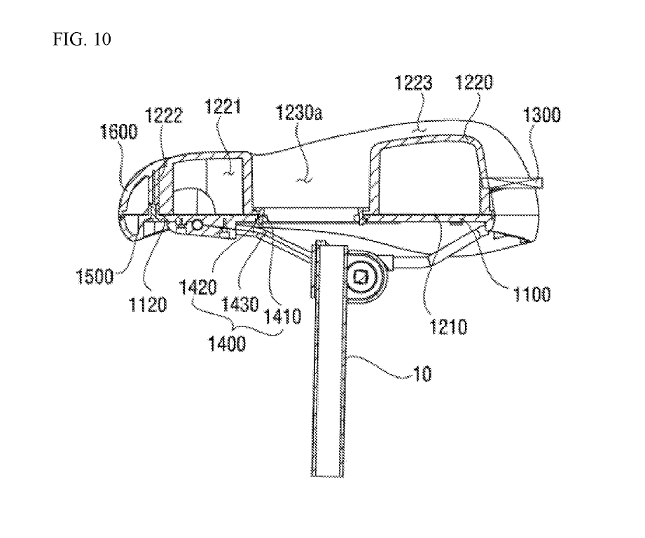

FIG. 6 is a perspective view of an air cushion saddle according to the second exemplary embodiment of the present invention, FIG. 7 is an exploded perspective view of an air cushion saddle in one direction according to the second exemplary embodiment of the present invention, FIG. 8 is an exploded perspective view of an air cushion saddle in another direction according to the second exemplary embodiment of the present invention, FIG. 9 is an enlarged perspective view of an anchor member according to the second exemplary embodiment of the present invention, and FIG. 10 is a cross-sectional view of an air cushion saddle according to the second exemplary embodiment of the present invention.

As shown in FIGS. 6 to 10, the air cushion saddle according to the second embodiment of the present invention may include a base plate 1100, a cushion member 1200, a valve member 1300, an anchor member 1400, a bolt member 1500 and a stiffening member 1600.

The base plate 1100 is mounted on a bicycle frame 10 to support the cushion member 1200 to be described later. The base plate 1100 is made of a hard and light synthetic resin material so as not to be easily damaged by a shock. As in the saddle of a common bicycle, the base plate 1100 has a narrow front and wide rear shape and is formed flat.

Furthermore, first venthole 1110 penetrating the upper and lower portions of the base plate 1100 are formed in the base plate 1100.

The first venthole 1110 communicate with the second venthole 1230 of the cushion member 1200 to be described later. The total of three ventholes, one at the center of the front and each one on both sides of the back, are provided.

In this case, the first venthole 1110 disposed on the front side has an oval long the front and the rear direction, and the remaining two first venthole 1110 have a circular shape.

In addition, a first bolt hole 1120 in which the bolt member 1500 to be described later is fastened is formed in the base plate 1100.

The first bolt hole 1120 is provided in the vicinity of the front end of the base plate 1100, and it protrudes in the direction of the cushion member 1200 in a cylindrical shape and has a tab formed therein to fasten the bolt member 1500 thereto.

In addition, the first fastening groove 1130 into which the lower end of the stiffening member 1600 is inserted and fastened are formed at the front and rear edges of the base plate 1100. The Second fastening groove 1140 into which the first wing part 1211 and the second wing part 1224 are inserted are formed at the edges of both sides of the base plate 1100.

Meanwhile, the cushion member 1200 is mounted on the top of the base plate 1100 and is a portion that directly comes into contact with the body of a rider.

Specifically, the cushion member 1200 is separated into a lower plate 1210 and an upper cover 1220.

The lower plate 1210 is formed of a plate made of NBR rubber and is formed to have a shape almost similar to a plane shape of the base plate 1100.

Furthermore, the second venthole 1230 communicating with the first venthole 1110 are formed in the lower plate 1210.

The second venthole 1230 are formed at the same position and in the same shape as the first venthole 1110.

Furthermore, the first wing part 1211 are protruded on both sides of the lower plate 1210.

The first wing parts 1211 are longly formed along the edges of both sides of the lower plate 1210. Upon assembling, the first wing parts 1211 are overlapped with the second wing part 1224 of the upper cover 1220 to be described later and are inserted and fixed to the first fastening grooves 1130.

The lower plate 1210 is adhesively fixed to the top of the base plate 1100 by an adhesive.

The upper cover 1220 is made of the same NBR rubber material as the lower plate 1210 and is mounted on the top of the lower plate 1210. The upper cover 1220 has formed a bottom open and the inside upward recessed.

The inside of the upper cover 1220 comes into contact with the lower plate 1210 to form a closed space 1221.

The upper cover 1220 may include a front portion 1220a which is disposed between the thighs of a rider and a rear portion 1220b which has a greater width than the front portion 1220a and on which the hips of a rider are disposed.

As in the lower plate 1210, the second venthole 1230 communicating with the first venthole 1110 are formed in the upper cover 1220.

The second venthole 1230 formed in the upper cover 1220 has the same shape as the second venthole 1230 formed in the lower plate 1210 and is disposed at the same position as the second venthole 1230.

Specifically, the second venthole 1230 formed in the upper cover 1220 may include a front venthole 1230a disposed in the front portion 1220a and a rear venthole 1230b disposed in the rear portion 1220b.

In this case, the front venthole 1230a is disposed at the center of the front portion 1220a in an oval long shape in the length direction, and one front venthole 1230a is disposed.

The rear venthole 1230b has a circular shape, and two rear venthole 1230b are spaced apart and disposed in the rear portion 1220b in such a way as to be symmetrical left and right.

In addition, a contact portion 1221 is formed to extend along the inner circumferential surface of the upper cover 1220 at the bottom of the second venthole 1230.

The contact portion 1221 is a portion engaged with the anchor member 1400 to be described later.

In addition, a second bolt hole 1222 which is connected to the first bolt hole and in which the bolt member 1500 is fastened is formed in the upper cover 1220.

The second bolt hole 1222 is disposed close the front of the upper cover 1220 and downward protrudes in a cylindrical shape.

In addition, a tab is formed in the second bolt hole 1222 so that the bolt member 1500 to be described later is fastened to the tab.

The second bolt hole 1222 is vertically aligned with the first bolt hole 1120. The bolt member 1500 to be described later is coupled up to the second bolt hole 1222 through the first bolt hole 1120, thus closely fixing the base plate 1100 and the cushion member 1200.

Furthermore, a ventilation 1223 that is open between the rear venthole 1230b from the front venthole 1230a is formed in the upper cover 1220.

The ventilation 1223 allows the air to circulate from the front of the upper cover 1220 to the rear along with the front air bore 1230a.

There are effects in that sweating between thighs upon riding a bicycle for a long time is minimized and friction with the upper cover 1220 is reduced to reduce the occurrence of a pain because the ventilation 1223 is formed in the upper cover 1220 from the front venthole 1230a to the rear side as described above.

In addition, the second wing part 1224 are formed on both sides of the bottom of the upper cover 1220.

The second wing part 1224 are formed in a thin film form and formed to lengthily protrude along the edges of both sides of the upper cover 1220.

When the cushion member 1200 is coupled to the base plate 1100, the wing part are folded along with the first wing part 1211 and inserted and fixed to the first coupling groove 1130 in such a way as to be erected.

As described above, the first wing part 1211 and the second wing part 1224 are formed in the cushion member 1200. Accordingly, there is an effect in that the airtightness of the closed space 1221 formed between the lower plate 1210 and the upper cover 1220 is improved by increasing the contact area of the lower plate 1210 and the upper cover 1220 when the cushion member 1200 is mounted on the base plate 1100.

In addition, the closed space 1221 in which air is received is formed and the second venthole 1230 communicating with the first venthole 1110 are formed within the cushion member 1200. Accordingly, there is an effect of further reducing the occurrence of a pain by distributing pressure upon contacting the body and circulating the air.

In addition, there are effects in that fabrication is convenient due to a simplified configuration and the upper cover 1220 can be easily replaced and repaired when it is damaged because the cushion member 1200 is separated into the lower plate 1210 and the upper cover 1220.

Meanwhile, the valve member 1300 is formed of the same Dunlop style valve as the tube of a bicycle wheel. A pump for charging a bicycle tube is connected to the valve member 1300 to inject air into the closed space 1221 of the cushion member 1200. When a nut at the end of the valve member 1300 is released, air within the cushion member 1200 can be discharged to the outside by a pressure difference.

As described above, the valve member 1300 is provided in the cushion member 1200. Accordingly, there is an effect in that a rider can freely implement desired ride comfort because the amount of air injected into the cushion member 1200 can be adjusted depending on the weight and body type of the rider.

Meanwhile, the anchor member 1400 is for closely fixing the cushion member 1200 to the base plate 1100. The anchor member 1400 is made of a synthetic resin material, and includes three members. The three members are respectively inserted into the first venthole 1110 and the second venthole 1230 communicating with each other and mounted thereon.

More specifically, the anchor member 1400 may include a body portion 1410, a support portion 1420 and hook portion 1430.

The body portion 1410 is a pipe form vertically penetrated and is inserted through the first venthole 1110 and the second venthole 1230 which communicate with each other.

In this case, the anchor member 1400 mounted on the front venthole 1230a has an oval shape like the front venthole 1230a, and the anchor member 1400 mounted on the rear venthole 1230b has a circular shape.

The support portion 1420 is formed to extend along an outer circumferential surface at the top of the body portion 1410 and comes into contact with the contact portion 1221 of the upper cover 1220.

In this case, fixing protrusion 1421 fixed to be embedded in the contact portion 1221 when they are closely attached to the contact portion 1221 are protruded from the support portion 1420.

The fixing protrusion 1421 become thinner in thickness downward and have pointed tips.

As described above, the fixing protrusion 1421 are formed in the support portion 1420. Accordingly, there is an effect of improving a coupling force because the fixing protrusion 1421 are deeply embedded in the support portion 1420 when the anchor member 1400 is mounted on the upper cover 1220.

The hook portion 1430 are formed at the bottom of the body portion 1410 and are hooked to the base plate 1100 so that the base plate 1100 and the cushion member 1200 are closely attached and fixed.

Specifically, the hook portion 1430 has a shape protruded outward from the body portion 1410 as shown in FIG. 3 and has both sides lengthily cut out up and down. Accordingly, the hook portion 1430 is elastically deformed inward when a specific force is applied thereto, and it returns to its original position when the force is removed.

The hook portion 1430 are symmetrically disposed on both sides of the bottom of the body portion 1410.

As described above, the anchor member 1400 may include the body portion 1410, the support portion 1420 and the hook portion 1430. Accordingly, there are effects in that air is prevented from easily leaking and the assembly property is convenient because the base plate 1100 and the cushion member 1200 are closely attached each other, the perfect closed space 1221 is formed within the cushion member 1200, and the airtightness of the inner circumferential surfaces of the first venthole 1110 and second venthole 1230 is improved.

Meanwhile, the bolt member 1500 is the same as a common bolt and fastened to be inserted into the second bolt hole 1222 through the first bolt hole 1120.

There is an effect of further improving the coupling force of the base plate 1100 and the cushion member 1200 because the bolt member 1500 fastened to the first bolt hole 1120 and the second bolt hole 1222 is provided.

Meanwhile, the stiffening member 1600 may include a first stiffening member 1610 enveloping the front of the cushion member 1200 and a second stiffening member 1620 enveloping the rear of the cushion member 1200.

Specifically, the first stiffening member 1610 is formed in the form of a thin shell that envelops the front of the cushion member 1200. A step is formed at the lower end of the first stiffening member 1610 and is inserted and fixed to the first fastening groove 1130 formed at the front of the base plate 1100.

The second stiffening member 1620 is formed in the form of a thin shell that envelops the rear circumference of the cushion member 1200. Likewise, a step is formed at the lower end of the second stiffening member 1620 and is inserted and fixed to the first fastening groove 1130 formed at the rear of the base plate 1100.

The first stiffening member 1610 and the second stiffening member 1620 are made of a synthetic resin material having higher strength than the material of the cushion member 1200, thus preventing the cushion member 1200 from being damaged by pressure.

In addition, the first stiffening member 1610 and the second stiffening member 1620 may be formed in various colors, so that the saddle can be designed in various designs.

In the air cushion saddle having the above structure according to the second exemplary embodiment of the present invention, the closed space 1221 into which air is injected is formed in the cushion member 1200 made of a rubber material having high elasticity and tensile force. Accordingly, there are effects in that a saddle pain attributable to the frequent friction and shock of a road surface is solved and ride comfort is provided upon riding a bicycle.

In particular, there are effects in that fabrication is convenient due to a simplified configuration and the upper cover 1220 can be easily replaced and repaired when it is damaged because the cushion member 1200 is separated into the lower plate 1210 and the upper cover 1220.

The present invention is not limited thereto and may be modified in various forms by those skilled in the art without departing from the spirit and scope of the following attached claims. Accordingly, such modification should be construed as belonging to the scope of the present invention.

### INDUSTRIAL APPLICABILITY

The present invention may be applied to an air cushion saddle field which can relieve a musculoskeletal system and skin pain generated around the pelvis upon riding a bicycle for a long time and can make smooth blood circulation.

What is claimed is:

1. An air cushion saddle, comprising:
a base plate (100) mounted on a bicycle frame (10) ;
a cushion member (200) mounted on a top of the base plate (100), made of a rubber material, and having a closed space (200a) in which air is received formed therein; and
a valve member (300) disposed in the cushion member (200) to open and close the closed space (200a).

2. The air cushion saddle of claim 1, wherein:
a first venthole (110) vertically penetrated is formed in the base plate (100), and second venthole (230) for distributing pressure and circulating air upon coming into contact with a body are vertically penetrated and formed in the cushion member (200) in such a way as to communicate with the first venthole (110).

3. The air cushion saddle of claim 2, wherein:
the cushion member (200) comprises a front portion (210) which is disposed between thighs of a rider and a rear portion (220) which has a wider width than the front portion (210) and in which hips of the rider are disposed, and
the second venthole (230) comprises:
a front venthole (231) formed in an oval long in a length direction of the cushion member (200) and disposed at a center of the front portion 210; and
two rear venthole (232) formed in a circular shape and spaced apart from each other on left and right sides of the rear portion (220).

4. The air cushion saddle of claim 1, wherein stiffening portion (240) made of a synthetic resin material having a higher tensile force than a material of the cushion member (200) are formed on front and rear surfaces of the cushion member (200).

5. The air cushion saddle of claim 1, wherein:
sliding portion (250) having a plurality of concave-convex parts are formed on both sides of the cushion member (200) in order to reduce friction with insides of thigh of a rider, and
non-slip portion (260) made of an adhesive material are formed on a top of the cushion member (200) in order to prevent slip through contact with a hip portion of the rider.

6. An air cushion saddle, comprising:
a base plate (1100) mounted on a bicycle frame and having a first venthole (1110) vertically penetrated formed therein;
a cushion member (1200) mounted on a top of the base plate (1100), made of a rubber material, having a closed space (1221) in which air is received formed therein, and having second venthole (1230) for distributing pressure and circulating air upon coming into contact with a body vertically penetrated and formed therein in such a way as to communicate with the first venthole (1110); and
a valve member (1300) disposed in the cushion member (1200) to open and close the closed space (1221),
wherein the cushion member (1200) comprises:
a lower plate (1210) mounted on the base plate (1100); and
an upper cover (1220) mounted on the lower plate (1210) and having a closed space (1221) formed therein, the closed space having a bottom open and an inside upward concaved and being sealed by the lower plate (1210).

7. The air cushion saddle of claim 6, further comprising an anchor member (1400) for closely fixing the cushion member (1200) to the base plate (1100),
wherein the anchor member (1400) comprises:
a body portion (1410) inserted into the first venthole (1110) and the second venthole (1230) therethrough;
a support portion (1420) extended from one end of the body portion (1410) and closely attached to any one surface of the base plate (1100) and the cushion member (1200); and
a hook portion (1430) formed at the other end of the body portion (1410) and hooked to the other surface of the base plate (1100) and the cushion member (1200).

8. The air cushion saddle of claim 7, wherein:
the support portion (1420) is closely fixed to the cushion member (1200),
a contact portion (1221) coming into contact with the support portion (1420) is extended and formed along an inner circumferential surface at a bottom of the second venthole (1230) of the cushion member (1200), and
fixing protrusion (1421) fixed to be embedded in the contact portion (1221) when the fixing protrusion (1421) are closely attached to the contact portion (1221) are formed in the support portion (1420).

9. The air cushion saddle of claim 6, further comprising a bolt member (1500) coupling the base plate (1100) and the cushion member (1200),
wherein a first bolt hole (1120) protruded in a direction of the cushion member (1200) and having the bolt member (1500) fastened therein is formed in the base plate (1100), and
a second bolt hole (1222) connected to the first bolt hole and having the bolt member (1500) fastened therein is formed in the cushion member (1200).

10. The air cushion saddle of claim 6, wherein:
the cushion member (1200) comprises a front portion (1220a) which is disposed between thighs of a rider and a rear portion (1220b) which has a wider width than the front portion (1220a) and in which hips of the rider are disposed,
the second venthole (1230) comprise:
a front venthole (1220a) formed in an oval long in a length direction of the cushion member (1200) and disposed at a center of the front portion (1220a); and
two rear venthole (1230b) each having a circular shape and spaced apart from each other on left and right sides of the rear portion (1220b), and
a ventilation (1223) open between the rear venthole (1230b) from the front venthole (1230a) is formed in the cushion member (1200).
